(19) United States
(12) Patent Application Publication
(10) Pub. No.: US 2015/0214875 A1
(43) Pub. Date: Jul. 30, 2015

(54) Motor Control Device Provided with Motor Unit and Inverter Unit

(71) Applicant: Hitachi Automotive Systems, Ltd., Hitachinaka-shi, Ibaraki (JP)

(72) Inventors: Hirokazu Matsui, Hitachinaka-shi (JP); Hiroyuki Yamada, Hitachinaka-shi (JP)

(21) Appl. No.: 14/420,392

(22) PCT Filed: Jul. 12, 2013
(86) PCT No.: PCT/JP2013/069088

§ 371 Date: Feb. 9, 2015

(30) Foreign Application Priority Data
Aug. 10, 2012 (JP) 2012-177722

(51) Int. Cl. H02P 6/14

(52) U.S. Cl. CPC H02P 6/147

(57) ABSTRACT

Provided is a motor control device that detects a position error between a detection position, calculated from a rotation position sensor signal of a motor, and a position of a motor induced voltage and performs phase correction. A motor control device 400 includes an inverter unit (motor drive unit) 100 and a motor unit 300. The inverter unit 100 includes a current control unit 120 that detects a drive current of a motor 310 and outputs a voltage command, a three-phase voltage conversion unit 130 that outputs a drive signal based on the voltage command that has been output, an inverter circuit 140 that supplies the motor with the drive signal, and a phase correction unit 170 that corrects a phase detected by a rotation position sensor 320. The phase correction unit includes a phase switching unit that switches between a phase for normal control and a phase for phase adjustment, and a phase error calculation unit that calculates a phase error equivalent to a mounting position error of the rotation position sensor. The mounting position error is corrected by adding/subtracting the phase error to/from the phase for normal control during phase correction operation.

### TECHNICAL FIELD

The present invention relates to a motor control device provided with a motor unit and an inverter unit, and in particular, relates to the motor control device provided with the motor unit and the inverter unit configured to output a motor applied voltage for detecting a position error between a detection position, which is calculated from a rotation position sensor signal of a motor, and a position of a motor induced voltage.

### BACKGROUND ART

In a motor control device using a synchronous motor, to appropriately control phases of a motor induced voltage and a motor applied voltage, it is desired that a detection position be detected from a rotation position sensor signal and the motor be driven by appropriately controlling the phase of the motor applied voltage.

For example, the motor control device described in PTL 1 is provided with: a lock conduction means that controls the motor such that a predetermined lock current is supplied by using the fact that an actual electrical angle becomes an ideal electrical angle when a lock current is supplied to an electric motor; an offset calculation means that calculates a deviation between an actual magnetic pole position, which is detected by a rotation angle detection means when the predetermined lock current is supplied to the motor by the lock conduction means, and an ideal magnetic pole position relative to the predetermined lock current supplied to the motor; and a correction means that corrects the actual magnetic pole position detected by the rotation angle detection means based on the deviation calculated by the offset calculation means. There is described a technology of detecting a position error between a detected position obtained from the rotation position sensor signal of the rotation angle detection means and a position of the motor induced voltage as well as of correcting the position error.

### CITATION LIST

### Patent Literature

PTL 1: JP 2003-319680 A

### SUMMARY OF INVENTION

### Technical Problem

In PTL 1, there is described a method of executing a series of processing in a device that performs motor control by using an actual electrical angle θm obtained from an input signal from the rotation angle detection means of the motor, the series of processing includes: to detect a deviation δθ from the position of the motor induced voltage, supplying motor lock currents Iu, Iv, and Iw such that an ideal electrical angle θ* is formed; drawing into a motor rotation position coinciding with the position of the motor induced voltage;

detecting a phase difference between the detected electrical angle θ and the ideal electrical angle θ* as the deviation δθ; and calculating a correction value based on the deviation between the actual magnetic pole position and the ideal magnetic pole position upon receiving a correction value acquisition request signal.

When drawing into the motor rotation position to be the ideal electrical angle θ*, however, as the deviation δθ between an actual electrical angle θm and the ideal electrical angle θ* is decreased, motor output torque is also decreased. In particular, in a case where the actual electrical angle θm coincides with the ideal electrical angle θ*, the motor output torque becomes zero. In an actual motor, since there are friction torque and cogging torque of a motor output shaft, the actual electrical angle θm does not coincide with the ideal electrical angle θ*, whereby the positional deviation δθ is caused. Since the positional deviation δθ directly becomes assembly and detection accuracy of a rotation angle sensor, it is desired that the positional deviation δθ be decreased, whereby a motor lock current is increased.

However, with regard to magnitude of the motor lock current, it is necessary to keep the magnitude thereof to a minimum from a relationship between loss and heat generation of an inverter circuit. There is also a problem in that a setting time of the motor rotation position becomes longer as the motor lock current is increased. Therefore, in the motor device in which the friction torque and the cogging torque change according to a position in which the motor is stopped, detection of an accurate detection position error (deviation δθ) has not been possible.

The present invention has been made in view of this problem, and an objective thereof is to provide a motor and an inverter device capable of detecting and controlling, with high accuracy, a phase error θer equivalent to the detection position error between a position θn, which is obtained from the input signal from a rotation position sensor of the motor, and the position of the motor induced voltage by cancelling magnitude of the friction torque and the cogging torque of the motor.

### Solution to Problem

To achieve the above objective, a motor control device according to the present invention includes: a motor unit including a motor and a rotation position sensor configured to detect a rotation position of a rotor of the motor; and a motor driving device configured to drive the motor by using a signal from the rotation position sensor, wherein the motor driving device is provided with: a current control unit configured to output a voltage command by detecting a drive current of the motor; a voltage conversion unit configured to output a drive signal based on the voltage command that has been output; an inverter circuit configured to supply the drive signal to the motor; and a phase correction unit configured to correct a phase detected by the rotation position sensor, wherein the phase correction unit is provided with a phase switching unit configured to switch between a phase for normal control and a phase for adjustment phase, and is provided with a phase error calculation unit configured to calculate a phase error equivalent to a mounting position error of the rotation position sensor, wherein during phase correction operation, the mounting position error is corrected by adding or subtracting the phase error to or from the phase for normal control.

### Advantageous Effects of Invention

According to a motor control device of the present invention, in detecting the phase error θer equivalent to an mounting position error between a position θn, which is obtained from the input signal from the rotation position sensor of the motor, and the position of the motor induced voltage, a conduction phase in which a phase is changed in a clockwise direction of the motor to offset motor friction torque, and a phase in which a phase is changed in a counterclockwise direction of the motor to offset the motor friction torque are output, whereby it is possible to detect the phase error θer with high accuracy by cancelling the magnitude of the friction torque and the cogging torque of the motor. That is, by gradually changing the phase from a minimum required conduction current in a d-axis direction to CW and CCW directions relative to the friction torque while the motor is stopped, and by detecting a position error from phase data at the time of offsetting the friction torque and feeding it back to a control phase, it is possible to correct the mounting position error of the rotation position sensor, whereby it is possible to precisely control operation of the motor.

### BRIEF DESCRIPTION OF DRAWINGS

FIG. 1 is a block diagram illustrating a control device of a motor according to one embodiment of the present invention.

FIG. 2 is a diagram illustrating a phase correction unit within the block diagram in FIG. 1.

FIG. 3 is a diagram illustrating a current command switching unit within the block diagram in FIG. 1.

FIG. 4A is a sectional view in a shaft direction illustrating a configuration of the motor in FIG. 1.

FIG. 4B is a sectional view in a radial direction cut along a line A-A′ in FIG. 4A.

FIG. 5A is a sectional view illustrating a principal part in an initial state before rotor positioning with regard to a sensor mounting error of the motor in FIGS. 4A and 4B.

FIG. 5B is a perspective view of the principal part in a state of ideal rotor positioning with regard to the sensor mounting error of the motor in FIGS. 4A and 4B.

FIG. 5C is a perspective view illustrating a principal part in a state of rotor positioning when friction exists with regard to the sensor mounting error of the motor in FIGS. 4A and 4B.

FIG. 6 is a characteristic chart illustrating a motor lock current and a motor rotation position according to a prior art.

FIG. 7 is a flowchart illustrating phase correction operation of the control device of the motor according to the present invention.

FIG. 8 is a diagram illustrating processing on a CW side describing the phase correction operation of the control device of the motor according to the present invention.

FIG. 9 is a diagram illustrating processing on a CCW side describing the phase correction operation of the control device of the motor according to the present invention.

### DESCRIPTION OF EMBODIMENTS

Hereinafter, a motor control device according to an embodiment of the present invention is described in detail with reference to the drawings.

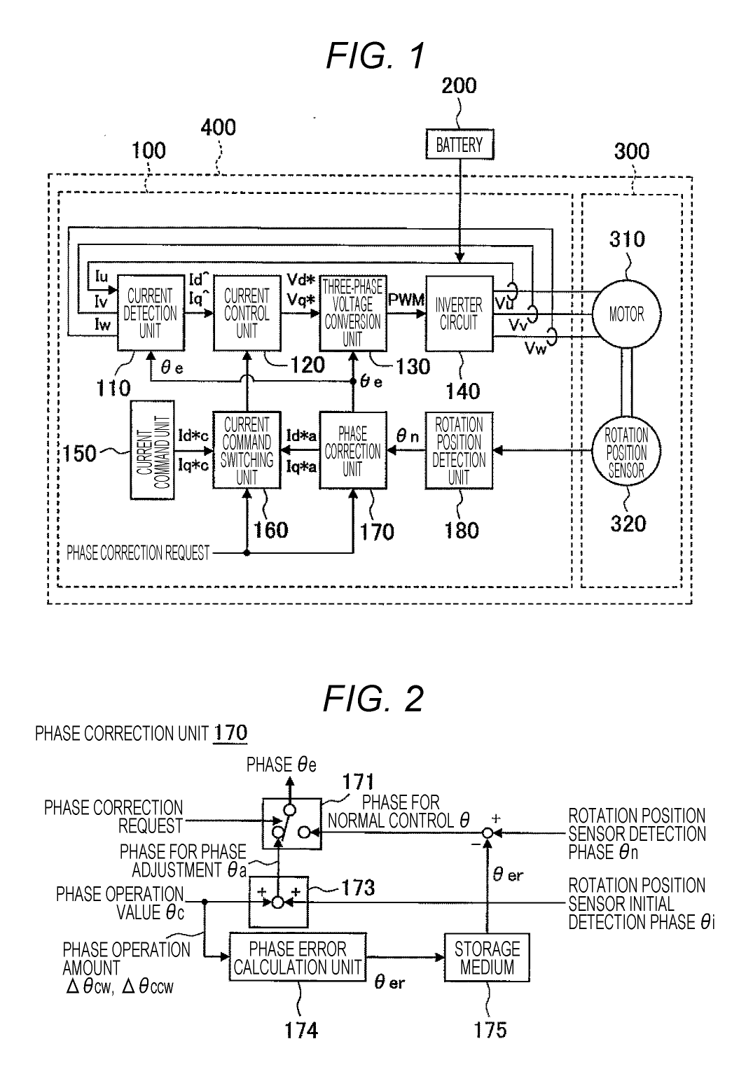

FIG. 1 is an entire block diagram illustrating the motor control device according to an example of one embodiment of the present invention. A control device 400 of a motor is suitable for use in driving the motor with high efficiency by detecting a mounting position error of a rotation position sensor of the motor and by correcting it when driving the motor. The control device 400 of the motor includes a motor unit 300 and an inverter unit 100. The inverter unit 100 constitutes a motor driving device.

The inverter unit 100 includes a current detection unit 110, a current command unit 150, a current control unit 120, a three-phase voltage conversion unit 130, an inverter circuit 140, a rotation position detection unit 180, a current command switching unit 160, and a phase correction unit 170. A battery 200 is a DC voltage source of the inverter unit 100, which is the motor driving device. A DC voltage Edc of the battery 200 is converted into a three-phase AC of a variable voltage and a variable frequency by the inverter circuit 140 of the inverter unit 100 and is applied to a motor 310.

The current detection unit 110 detects an electric current of the three-phase AC supplied from the inverter circuit 140 to the motor 310. The current command unit 150 inputs current command values for torque control (Id*c and Iq*c) to the current command switching unit 160 based on a torque command. The phase correction unit 170 inputs current command values for phase adjustment (Id*a and Iq*a) to the current command switching unit 160 based on a phase correction request. To the current control unit 120, current command values for current control (Id* and Iq*) are input from the current command switching unit 160. To the three-phase voltage conversion unit 130, voltage commands (Vd* and Vq*) are input from the current control unit 120. The inverter circuit 140 supplies a PWM drive signal, which is pulse width modulated, from the three-phase voltage conversion unit 130 to the motor 310.

The motor 310 is a synchronous motor rotary driven by being supplied the three-phase AC. To the motor 310, a rotation position sensor 320 is mounted for controlling a phase of an applied voltage of the three-phase AC according to a phase of an induced voltage of the motor 310. A detection position θn is calculated from an input signal of the rotation position sensor 320 in the rotation position detection unit 180. Here, a resolver constituted of an iron core and a winding wire is preferred as the rotation position sensor 320; however, it may also be a GMR sensor or a sensor using a Hall element.

The inverter unit 100 has a current control function for controlling output of the motor 310, and outputs current detection values (Id̂ and Iq̂), which is d-q converted from three-phase motor current values (Iu, Iv, and Iw) and a rotation angle θe in the current detection unit 110. The current control unit 120 outputs the voltage commands (Vd* and Vq*) such that the current detection values (Id̂ and Iq̂) coincide with the current command values (Id* and Iq*) output from the current command switching unit 160. In the three-phase voltage conversion unit 130, by a drive signal that is once converted into the three-phase motor applied voltage from the voltage commands (Vd* and Vq*) and the rotation angle θe and is pulse width modulated (PWM), a semiconductor switching element of the inverter circuit 140 is on/off controlled for adjusting an output voltage.

Then, the phase correction unit 170 of this example is described by using FIG. 2. The phase correction unit 170 uses a detection phase θn from the rotation position sensor 320 and the phase correction request received through CAN communication and the like as input information, and it outputs the rotation angle for control θe. The rotation angle for control θe is a phase for phase adjustment θa or a phase for normal control θ. The information is switched and determined by the phase correction request in a phase switching unit 171.

The phase for phase adjustment θa is obtained by adding a rotation position sensor initial detection phase θi to a phase operation value θc in a phase adder 173. The phase operation value θc is a value that changes in a CW direction (clockwise direction) or in a CCW direction (counterclockwise direction) relative to the initial detection phase θi. Phase operation amounts Δθcw and Δθccw operated at this time are input into a phase error calculation unit 174 as phase errors. In the phase error calculation unit 174, a phase error θer is calculated from the phase operation amounts Δθcw and Δθccw in the CW direction and the CCW direction and is stored in a storage medium 175. The stored phase error θer is subtracted from the phase for a rotation position sensor detection θn to obtain the phase for normal control θ. Note that in a case where a phase adjustment is not performed at all, it is preferred that an initial value be used as the phase error θer for calculating the phase for normal control θ. In this example, the CW direction is a lead angle side, and the CCW direction is a lag angle side.

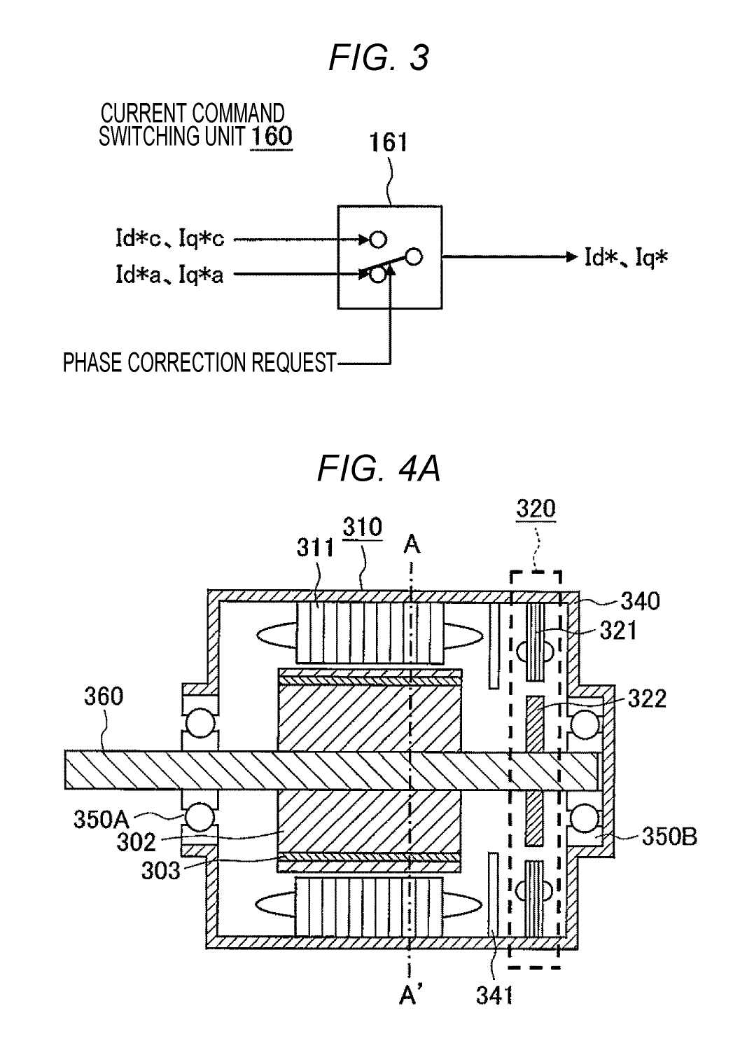

Then, the current command unit 150 and the current command switching unit 160 according to this example are described by using FIG. 3. Among the current command values, there are the current command values for torque control (Id*c and Iq*c), which are determined by the torque command, and the current command values for phase adjustment (Id*a and Iq*a), which are used during the phase adjustment. These current command values have a configuration in which the current command values for current control (Id* and Iq*) are obtained by performing switching by the phase correction request. Note, however, that at this time, the current command values for phase adjustment (Id*a and Iq*a) are not 0 [A] only for a d-axis current, which is not caused by torque generation, and are 0 [A] for a q-axis current. Here, not 0 [A] means it is not 0 [A].

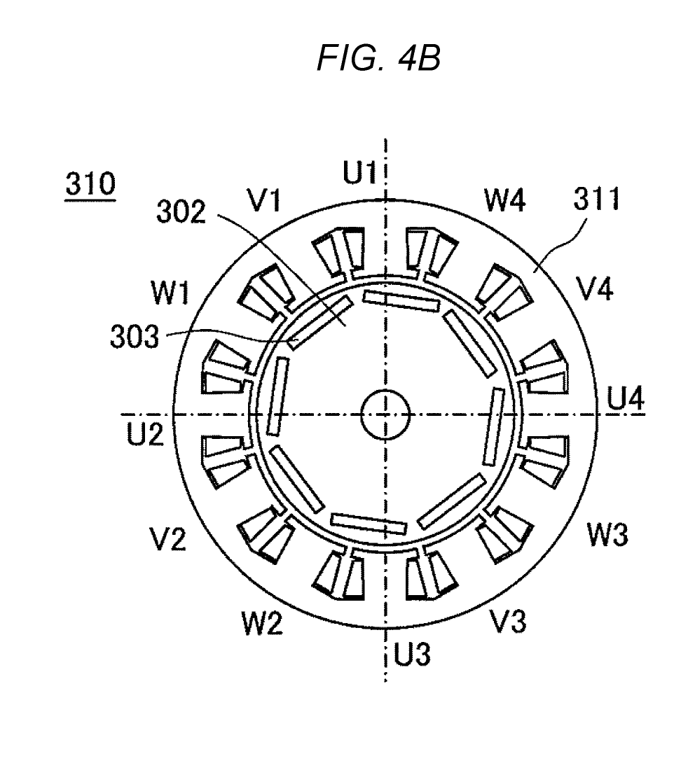

Then, a configuration of the motor 310 according to this example is described by using FIGS. 4A and 4B. FIG. 4A is a sectional view illustrating the motor 310 in a shaft direction, and FIG. 4B is a view illustrating a section in a radial direction (A-A′) relative to a section in the rotor shaft direction of the motor 310. The motor illustrated herein is a permanent magnet synchronous motor having a permanent magnetic field, and in particular, it is an interior permanent magnet synchronous motor in which a permanent magnet is embedded in a rotor core. In a stator 311, around a tooth of a stator core, three-phase winding of a U phase (U1 to U4), a V phase (V1 to V4), and a W phase (W1 to W4) is wound in order. Inside the stator 311, through a gap, a rotor 302 (constituted of the rotor core, a permanent magnet 303, and a rotor shaft 360) is arranged, whereby it is an inner rotor type motor.

There is the rotation position sensor 320 inside a motor housing, and a magnetic shield plate 341 is set between the stator 311 and the rotation position sensor 320. A sensor stator 321 of the rotation position sensor is fixed to a motor housing 340. A sensor rotor 322 of the rotation position sensor is connected to the rotor 302 (rotor) through the rotor shaft 360, and the rotor shaft 360 is rotary supported by bearings 350A and 350B. Note that the motor is a concentrated winding type motor; however, it may also be a distributed winding motor. The resolver is used in the rotation position sensor 320; however, in a case where the Hall element and the GMR sensor are used, by using an excitation signal for a bias voltage of a sensor element, detection is possible in the same way, and there is no problem.

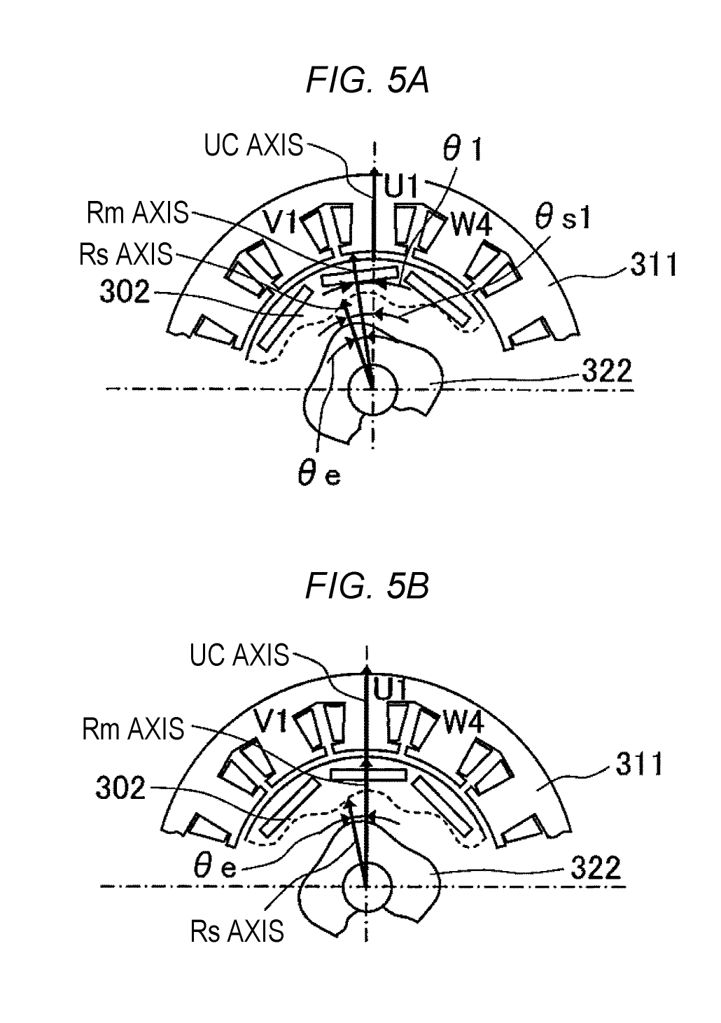

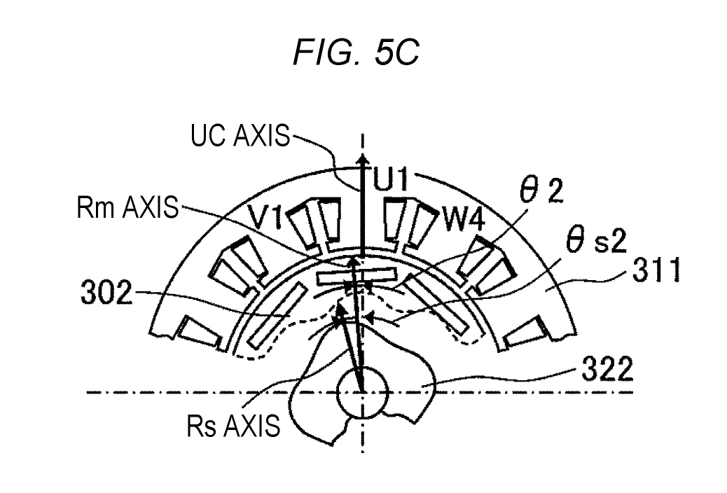

Then, a sensor mounting error according to this example is described with reference to FIGS. 5A to 5C. To illustrate a counter electromotive voltage phase of the motor and the mounting position error of the rotation position sensor, FIGS. 5A to 5C are views schematically illustrating the section in a radial direction of the motor viewed from the sensor rotor side with regard to a positional relationship between the stator 311 and the rotor 302 of the motor 310 as well as the sensor rotor 322 of the rotation position sensor 320. Here, consideration on the mounting position error of the sensor stator can be treated as the mounting position error of the sensor rotor, for convenience. The resolver of the sensor rotor is a quadrupole type and is capable of being changed according to the number of pole pairs of the motor.

FIG. 5A is a view illustrating an initial state before rotor positioning, and it is in a motor stopped state before conduction of an inverter. A magnetic flux axis (Rm axis) of a magnet of the rotor 302 of the motor, or a d-axis of the motor relative to a U phase coil axis (UC axis) of the stator 311, is at a position θ1. An axis of a salient pole (0 degree) of the sensor rotor 322 is a resolver rotor axis (Rs axis), which is at a detection position θs1 of the rotation position sensor. A positional displacement between the Rm axis and the Rs axis is a mounting position error θer, which is a positional displacement amount determined by the mechanical mounting position error, and it can be referred to as an individual difference for each of the motors determined after assembly of the motors. In a case where the mounting position error can be managed to be ±1 degree of a mechanical angle, for a motor having four pole pairs, the positional displacement amount of an electrical angle used in motor control is quadrupled to ±4 degrees, and for a motor having eight pole pairs, it is equivalent to ±8 degrees of the electrical angle. The position error of this electrical angle becomes a current control error in the motor control of a weaker field control, and since it leads to increased energy consumption by the motor, it is necessary to manage the position error of the electrical angle to be small. Note that a rotation position of the motor that is not particularly specified is treated as the electrical angle.

In general, since management by mechanical accuracy is difficult, the position error is measured in advance and is retained in a non-volatile memory inside the inverter, and a rotation angle θ, which is obtained by correcting the detection position θs1 with the phase error measured in advance in the phase correction unit 170, is used and applied to the motor control. Therefore, a function that performs automatic adjustment by incorporating logic, which measures the phase error in advance, into the inverter is desired. For example, there has been known a method in which a lock current is conducted in the motor, the motor rotation position is positioned by drawing in, and a deviation between a conduction phase at this time and the detection position θs1 is a detection position error θe. At this time, there is friction torque in an output shaft of the motor, and torque fluctuation (e.g. cogging torque) is caused by magnetic flux distribution, which is determined by structures of the stator 311 and the permanent magnet 303 of the rotor 302.

FIG. 5B is a view illustrating an ideal state in which the friction torque and the cogging torque do not exist, and the detection position error θe, which is obtained from a deviation between the UC axis of the conduction phase and a detection position θs1, is equal to the mounting position error. However, since there is an influence of the friction torque and the cogging torque in actuality, as illustrated in FIG. 5C, the Rm axis of an actual device does not coincide with the UC axis of the conduction phase, whereby there is a position displacement amount θs2, and detection accuracy of the detection position error is decreased.

On the other hand, motor torque is expressed by formula 1.

T=Pn·{φ·Iq+(Ld−Lq)·Id·Iq} (formula 1)

where, T: motor torque, Pn: number of pole pairs, φ: amount of magnetic flux of the motor, Ld: d-axis inductance, Lq: q-axis inductance, Id: d-axis current, and Iq: q-axis current. When a phase angle of the q-axis and a current I is β, it is expressed by formula 2.

T=Pn·{φ·I·cos β+½×(Ld−Lq)·I²·sin(2β)} (formula 2)

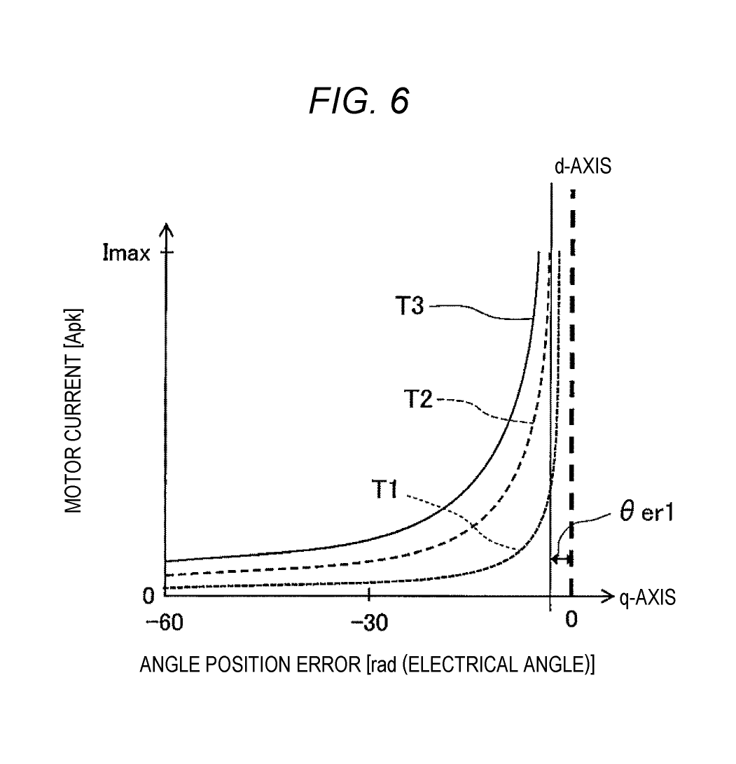

When the motor lock current I is conducted and the motor rotation position is drawn in, the motor torque becomes T=0 to set to a state of Iq=0 and Id=I. Therefore, in actuality, the motor rotation position stops at a position where the friction torque is balanced with the motor torque. As illustrated in FIG. 6, when the friction torque is T3>T2>T1, an angle position error becomes larger as the friction torque becomes larger. When a motor current is increased, the angle position error becomes smaller; however, it converges into the specific angle position error. For example, when the friction torque is T2, the angle position error converges into θer1. Note that the angle position error is basically the same as the mounting position error of the rotation position sensor.

In a case where magnitude of the friction torque is changed with the motor rotation position or in a case where viscous resistance is changed with a temperature change, it is not possible to accurately detect the position error, whereby it is inevitable to keep the influence of the friction torque to a minimum.

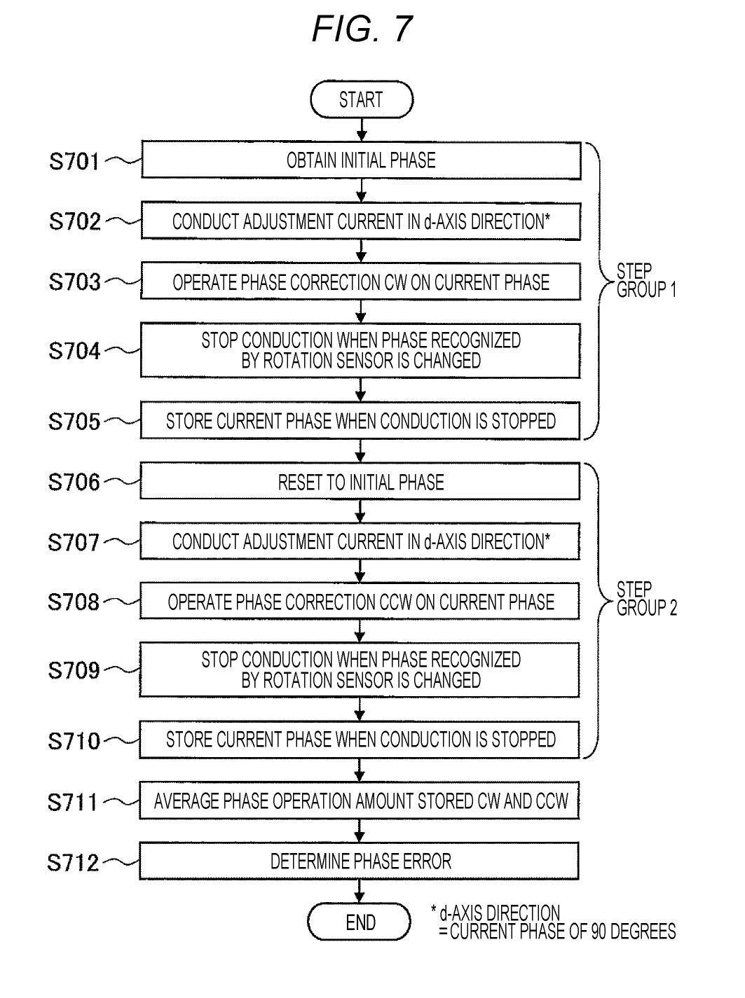

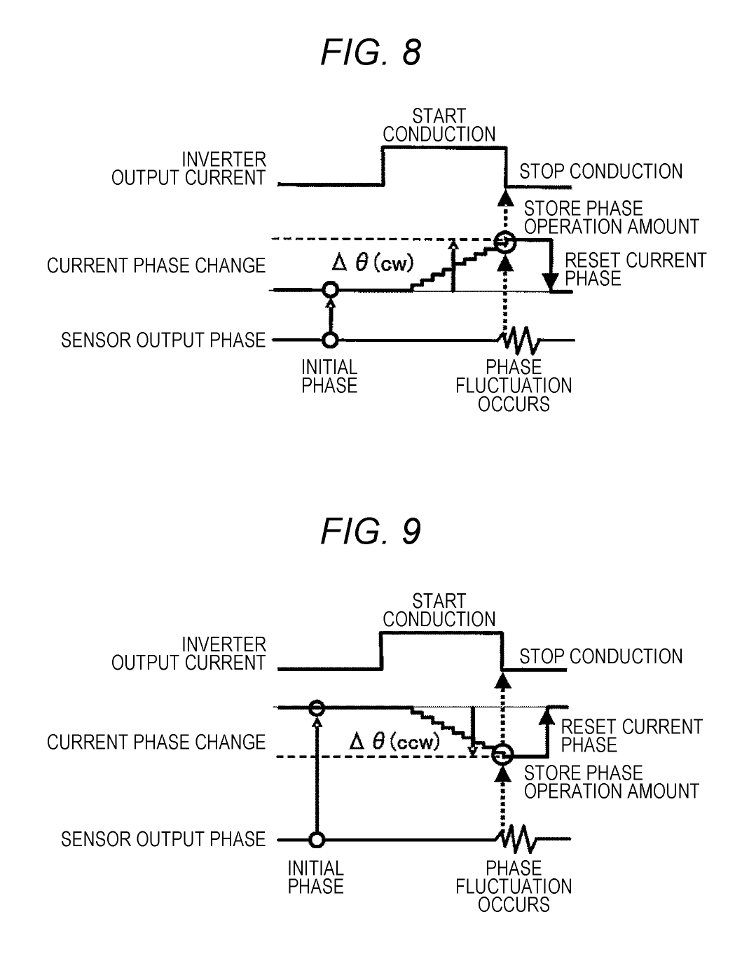

Then, phase correction operation according to this example is described by using FIGS. 7 to 9. FIG. 7 is a flowchart illustrating the phase correction operation, FIG. 8 is the phase correction operation in the CW direction, and FIG. 9 is the phase correction operation in the CCW direction. The flowchart in FIG. 7 is executed as a microcomputer program of a control device of the inverter.

Firstly, in the motor stopped state, phase information is obtained from the rotation position sensor 320 based on the phase correction request in FIG. 1 (S701). This data is hereinafter used as an initial detection phase (θi). Then, an electric current for the phase adjustment is conducted in the motor (S702). This adjustment current is in a d-axis direction of a current phase of +90 degrees, and is illustrated as “start conduction” in FIG. 8. Since the conduction phase at this point is only in the d-axis direction on a rotation coordinate, ideally, the motor generates no torque, whereby a phase change does not occur. Note that determination of magnitude of conduction current is described below.

Then, while retaining the above state, the phase data is added to initial detection phase in the CW direction, and the current phase is phase correction operated CW (S703). In FIG. 8, it is changed stepwise as a current phase change. In this correction operation, while retaining a current command at the d-axis current, a current value on a rotation coordinate system is moved to a q-axis side, and an electric current to be conducted in the motor is operated from a state in which the d-axis current is not 0 A and the q-axis current is 0 A to a state in which the d-axis current and the q-axis current are not 0 A. In this case, since the q-axis current is not 0 A, the electric current that generates torque is to be conducted in the motor. Note, however, that the torque is not immediately generated even when the q-axis current is not 0 A since there is the friction torque in the motor, whereby the phase is not to be changed.

In this way, during the phase correction operation, the phase correction unit 170 determines the magnitude of the electric current to be conducted in the phase adder 173 for the phase adjustment from a value of the torque necessary for changing from a stopped state to a not stopped state of output of the rotation position sensor. Then, in a case where the phase change does not appear even if the phase operation amount is operated within a possible range, the phase adjustment is performed again by increasing an amount of conduction. Also, the phase correction unit 170 performs the phase correction operation only at timing where no change appears in a phase value that is output from the rotation position sensor 320, for example, during start of the inverter, which is in the motor stopped state, or during stop processing of the inverter, which is in the motor stopped state. Furthermore, the phase correction unit 170 may perform the phase correction operation during the start of the inverter and during the stop processing of the inverter.

Then, when adding of the above-described phase data is continued, since a component of the q-axis current eventually becomes large, torque exceeding the friction torque is generated, and a change begins to appear in the phase value obtained from the rotation position sensor. As illustrated in a sensor output phase in FIG. 8, phase fluctuation occurs. At the point of entering this state, conduction of the motor is stopped (S704), and the phase operation amount (Δθcw) added in the CW direction is stored in a volatile memory or the non-volatile memory of a microcomputer (S705). The above constitutes correction operation of a step group 1. After the correction operation of the step group 1 is ended, the phase operation amount that has been added in the CW direction is set to 0 degree, and the current phase is reset as illustrated in FIG. 8.

Then, the phase information is obtained from the rotation position sensor 320 while the motor is in a stopped state (S706). This data is hereinafter used as the initial phase for the next operation. Then, in the same way as the above-described CW direction, the electric current for the phase adjustment is conducted in the motor (S707). This adjustment current is also in the d-axis direction of the current phase of +90 degrees, and is illustrated as “start conduction” in FIG. 9. Since the conduction phase at this point is only in the d-axis direction on the rotation coordinate, ideally, the motor generates no torque, whereby the phase change does not occur.

Then, while retaining the above state, the phase data is added to the initial phase in the CCW direction, and the current phase is phase correction operated CCW (S708). In FIG. 9, it is changed stepwise as the current phase change. In this correction operation, similar to the above-described CW direction, while retaining the current command at the d-axis current, the current value on the rotation coordinate system is moved to the q-axis side, and the electric current to be conducted in the motor is operated from the state in which the d-axis current is not 0 A and the q-axis current is 0 A to the state in which the d-axis current and the q-axis current are not 0 A. In this case, since the q-axis current is not 0 A, the electric current that generates the torque is to be conducted in the motor. Note, however, that the torque is not immediately generated even when the q-axis current is not 0 A since there is the friction torque in the motor, whereby the phase is not to be changed.

Then, when the adding of the above-described phase data is continued, similar to the above-described CW direction, since the component of the q-axis current eventually becomes large, the torque exceeding the friction torque is generated, and the change begins to appear in the phase value obtained from the rotation position sensor. As illustrated in the sensor output phase in FIG. 9, the phase fluctuation occurs. At the point of entering this state, the conduction of the motor is stopped (S709), and a phase operation amount (Δθccw) added in the CCW direction is stored in the volatile memory or the non-volatile memory of the microcomputer (S710). The above constitutes correction operation of a step group 2.

The phase error is obtained from the phase operation amounts obtained in the step group 1 and the step group 2 by formula 3 (S711). In this process, phase operation amounts Δθcw and Δθccw, each in a different direction, are averaged to determine the phase error θer (S712). In this way, phase correction is performed at timing where the phase fluctuation occurs and no change appears in the phase value output from the sensor. In particular, it is preferred that the phase correction be performed when the inverter is started while the motor is stopped and during the stop processing of the inverter.

θer=(Δθcw−Δθccw)/2 (formula 3)

The phase error (θer) that has been obtained is retained in the storage medium 175 such as the non-volatile memory, is processed within the phase correction unit 170, and is applied to a correction value of the phase data for the motor control. A scalar quantity of the electric current to be conducted during the phase adjustment is determined by the magnitude of the cogging torque of the motor to be adjusted and the friction torque of auxiliary machinery and the like accompanying the motor output shaft.

Now, when a total value of the friction torque is Tf, it is possible to offset the friction torque by generating torque equal to Tf by the motor. Accordingly, the scalar quantity of the conduction current is determined by using the above-described motor torque operation expression (formula 1). Based on formula 1, in order to determine the minimum required conduction current for generating the friction torque, only a pure magnet torque (Tm) portion is obtained excluding a reluctance torque portion. This is expressed by formula 4.

Tm=Pn·φ·Iq (formula 4)

When the magnet torque calculated here is replaced with the friction torque (Tf), and further when Iq is the scalar quantity of the conduction current (I) formula 4 can be expressed by formula 5.

Tf=Pn·φ·I (formula 5)

Based on formula 5, the scalar quantity of the conduction current (I) is expressed by formula 6.

I=Tf/(Pn·φ) (formula 6)

When the friction torque is fluctuated due to aged deterioration of the magnet used in the motor and due to a load change of the output shaft, in a case where phase adjustment processing is performed with an initial setting current value, there is a possibility that the phase change does not appear even by maximum phase operation. In this case, by performing the step groups 1 and 2 again by increasing the conduction current, it is possible to allow load torque fluctuation to be absorbed.

A motor driving device 100 of the present invention is capable of correcting an initial position displacement amount with a minimum amount of conduction according to the magnitude of the friction torque, whereby it has an advantage of being capable of correcting the initial position displacement amount even after it is assembled to a vehicle.

In the motor driving device for a vehicle, in a case where abnormality and the like occurs to a motor or a transmission, it is preferred that it be overhauled and reassembled at a service station. In the phase correction unit 170 of the present invention, even if the mounting position error of the rotation position sensor 320 is changed, the mounting position error after a maintenance repair in the service station is detected by allowing the service to perform a phase adjustment request, and the detected position error is rewritten in the non-volatile memory, whereby there is an advantage in that operation with high efficiency using an appropriate rotation position becomes possible.

In the above-described embodiment, a case in which the motor driving device 100 of the present invention is applied to a hybrid vehicle system has been described; however, the same effect can be obtained with an electric vehicle as well. As the motor, the three-phase AC synchronous motor has been exemplified; however, the motor is not to be limited to this, and it is also possible to use a motor of other type.

Although the embodiments of the present invention have been described as above, the present invention is not to be limited to these embodiments, and various design changes are possible within a scope not deviating from spirit of the present invention described in claims. For example, the above-described examples have been described in detail so as to facilitate understanding of descriptions of the present invention, whereby it is not to be limited to one provided with all of the described constituents. It is also possible to replace apart of constituents of one example with a constituent of another example or to add the constituent of the other example to the constituent of one example. Addition of another constituent, deletion, and replacement are possible for a part of the constituents of each of the examples.

As for a control line and an information line, ones considered to be necessary for description have been illustrated, whereby not all of the control lines and the information lines of a product are described. In actuality, it may be considered that almost all of the constituents are mutually connected.

### INDUSTRIAL APPLICABILITY

As a use example of the present invention, it is possible to drive various motors by using this control device of a motor. It is also possible to apply it to use such as a motor of an electric power steering and a motor of an electric seat.

### REFERENCE SIGNS LIST

100 inverter unit (motor driving device)
110 current detection unit
120 current control unit
130 three-phase voltage conversion unit (voltage conversion unit)
140 inverter circuit unit
150 current command unit
160 current command switching unit
161 current command switching device
170 phase correction unit
171 phase switching unit
173 phase adder
174 phase error calculation unit
175 storage medium (storage means)
180 rotation position detection unit,
200 battery,
300 motor unit
310 motor
311 stator
302 rotor
303 permanent magnet
320 rotation position sensor
321 sensor stator
322 sensor rotor
340 motor housing
350A bearing 1
350B bearing 2
360 rotor shaft,
400 motor control device

1. A motor control device comprising:
a motor unit including a motor and a rotation position sensor configured to detect a rotation position of a rotor of the motor; and
a motor driving device configured to drive the motor by using a signal from the rotation position sensor, wherein
the motor driving device is provided with:
a current control unit configured to output a voltage command by detecting a drive current of the motor;
a voltage conversion unit configured to output a drive signal based on the voltage command that has been output;
an inverter circuit configured to supply the drive signal to the motor; and
a phase correction unit configured to correct a phase detected by the rotation position sensor, wherein
the phase correction unit is provided with a phase switching unit configured to switch between a phase for normal control and a phase for adjustment phase, and is provided with a phase error calculation unit configured to calculate a phase error equivalent to a mounting position error of the rotation position sensor, wherein
during phase correction operation, the mounting position error is corrected by adding or subtracting the phase error to or from the phase for normal control.

2. The motor control device according to claim 1, wherein
the phase correction unit is configured to obtain the phase for adjustment phase based on an initial detection phase of the rotation position sensor when the rotor is stopped.

3. The motor control device according to claim 1, wherein
the phase error calculation unit is configured to change a current control phase to a lead angle side or a lag angle side.

4. The motor control device according to claim 1, wherein
the phase correction unit is provided with a storage means configured to store a phase operation amount when conduction is stopped to a lead angle side and a lag angle side for a phase operation value.

5. The motor control device according to claim 4, wherein
the phase correction unit is configured to calculate the phase error by averaging the stored phase operation values.

6. The motor control device according to claim 1, wherein
the phase correction unit, during the phase correction operation, is configured to determine magnitude of an electric current to be conducted for phase adjustment from a value of torque required for changing output of the rotation position sensor from a stopped state to a not stopped state.

7. The motor control device according to claim 1, wherein
the phase correction unit, during the phase correction operation, is configured to perform the phase adjustment again by increasing a conduction current in a case where a phase change does not appear even when the phase operation amount is operated within a possible range.

8. The motor control device according to claim 1, wherein
the phase correction unit is configured to perform the phase correction operation at timing where no change appears to a phase value output by the rotation position sensor.

9. The motor control device according to claim 8, wherein
the phase correction unit is configured to be performed when an inverter is started while the motor is stopped and/or during stop processing of the inverter.
